(19) United States
(12) Patent Application Publication
(10) Pub. No.: US 2021/0254505 A1
(43) Pub. Date: Aug. 19, 2021

(54) EXHAUST GAS TURBOCHARGER WITH INTEGRATION OF BEARING COMPONENTS

(71) Applicant: MAN Energy Solutions SE, Augsburg (DE)

(72) Inventor: Harald DENKEL, Baar (DE)

(73) Assignee: MAN Energy Solutions SE

(21) Appl. No.: 17/119,376

(22) Filed: Dec. 11, 2020

(30) Foreign Application Priority Data
Dec. 13, 2019 (DE) 10 2019 134 241.4

(51) Int. Cl. F01D 25/16; F01D 25/18

(52) U.S. Cl. CPC F01D 25/168; F05D 2240/52; F05D 2220/40; F01D 25/18

(57) ABSTRACT

An exhaust gas turbocharger includes: a compressor wheel; a turbine; and a shaft configured to rotatably interconnect the compressor wheel and the turbine. The shaft is mounted in the turbocharger by a bearing configured to absorb axial forces acting on the shaft. The turbocharger further includes a one-piece thrust ring arranged on the shaft, the one-piece thrust ring indirectly connecting the shaft with the bearing and being configured to transmit the axial forces acting on the shaft both in a thrust direction and in a counter-thrust direction opposite to the thrust direction.

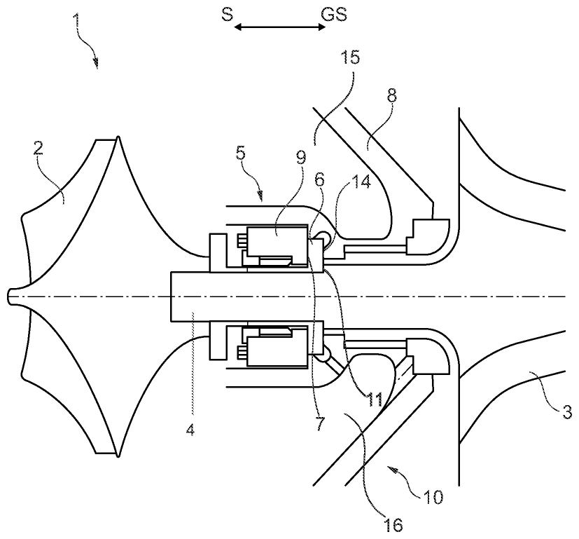

### BACKGROUND OF THE INVENTION

### 1. Field of the Invention

The invention relates to an exhaust gas turbocharger having a compressor wheel, a turbine and a shaft, which rotatably interconnects the compressor wheel and the turbine.

### 2. Description of the Related Art

The bearing of an exhaust gas turbocharger is designed to absorb an axial thrust of the rotating components in two directions. Introducing the forces into the bearing housing or the stator is effected by a component, a thrust bearing, specifically provided for this purpose. On the rotor of the exhaust gas turbocharger, two components, a thrust ring, a counter-thrust ring for the force transmission are needed to be able on the one hand to mount the rotor, and on the other hand absorb axial forces in two directions at the same time, or direct these into the thrust bearing. Disadvantageous in this arrangement is that the two thrust rings and consequently also further components have a relatively large radial and axial extent, as a result of which much installation space for the exhaust gas turbocharger is needed. In addition, this results in that the cooling and lubrication of the exhaust gas turbocharger is highly complex and expensive.

### SUMMARY OF THE INVENTION

An object of the present invention therefore is to provide an exhaust gas turbocharger which requires a reduced installation space, has a reduced weight and optimizes the cooling and lubrication of the components.

This object may be achieved, according to an aspect of the invention, by an exhaust gas turbocharger having a compressor wheel, a turbine and a shaft, which rotatably interconnects the compressor wheel and the turbine is proposed. The shaft is mounted by means of a bearing for absorbing axial forces. Furthermore, a one-piece thrust ring is arranged on the shaft that indirectly connects the shaft with the bearing and is configured to transmit the axial forces acting on the shaft both in a thrust direction and also in the counter-thrust direction opposite to the thrust direction.

In contrast with the prior art, the axial forces are not introduced into the bearing via two rotor components, but the force introduction is effected by way of a one-piece component, the thrust ring, by which forces in the thrust direction and counter-thrust direction are directed into the stator components. Because of the changed arrangement, the bearing function can be realized with fewer components that are smaller in the radial extent. Furthermore, more installation space for an oil drainage and a cooling is provided for the reduced radial extent. This improves the cooling effect since more cooling area is present in the relevant region behind the compressor wheel and the turbine rotor. In addition to this, the use of more stable cores for the cast bearing housing is made possible because of the installation space gained.

In an advantageous embodiment version it is provided that the thrust ring comprises a thrust surface for absorbing the axial force in the thrust direction, which lies against the bearing such that axial forces in the direction of the compressor wheel are absorbed by the bearing. In addition, the thrust ring comprises a counter-thrust surface for absorbing the axial force in the counter-thrust direction that lies against the bearing such that axial forces in the direction of the turbine are absorbed by the bearing. Because of this arrangement, the main thrust bearing migrates in the direction of the compressor wheel. Because of this, the stiffness of the shaft is increased since on the one hand the shaft shoulder can be moved further in the direction of the compressor wheel, and thus a longer portion of the shaft has the large diameter of the shoulder. On the other hand, the number of the small parts of the rotor can be reduced and the remaining small parts can be configured shorter in the longitudinal extent. In addition there is the possibility of integrating the wedge surfaces of the bearing, above all with respect to the counter-thrust surface of the thrust bearing, in the rotor components or the thrust ring. The wedge surfaces usually wear out, which is why it additionally brings with it advantages for a service since the wear parts are arranged on a more cost-effective component of the exhaust gas turbocharger.

In an exemplary embodiment of the invention it is provided that the bearing is formed of a bearing housing and a bearing body of a stator. This is advantageous because the lower number of parts of the small rotor parts the tightening torque can be better defined and a lower spread has to be applied in the design of the components of the exhaust gas turbocharger.

Preferentially, the exhaust gas turbocharger is configured such that in the bearing body a thrust bearing is integrated, which is in contact with the thrust ring and designed for absorbing axial forces in the direction of the compressor wheel. Through the integrated thrust bearing, the bearing housing has a more compact radial extent than the previous combination of a bearing body and a thrust bearing, for example with respect to the connecting elements or a necessary residual wall thickness. Because of this, the component weight in the interior region of the exhaust gas turbocharger is reduced with increased stiffness.

Furthermore, an embodiment is favorable in which the thrust ring with the counter thrust-surface lies against the bearing housing for absorbing the axial forces in the direction of the turbine. In this way, a counter-thrust bearing is integrated in the bearing housing. The function of the counter-thrust bearing can be optimally embodied as additional component on the stator or bearing housing. A slotted nut with a thread on an outer diameter and grooves on an inner diameter is exemplarily conceivable here. The grooves can serve both for oil lubrication and also for disassembly. Furthermore, the wedge profiles of the bearing can be arranged on a flank of the slotted nut.

In a further advantageous version it is provided according to an aspect of the invention that between the thrust ring and the bearing housing a further component for the force transmission is arranged. Because of this, the wedge surface of the bearing in the counter-thrust direction is arranged on a race or an additional housing component. Corresponding to the material properties of the component, the further component optimizes the properties of the bearing with respect to a friction coefficient and the wear.

In an embodiment version, the exhaust gas turbocharger according to an aspect of the invention is configured so that the thrust ring is non-positively arranged on the shaft and, with a part of the counter-thrust surface, lies against a shaft shoulder. In this way, the thrust ring is secured against an axial position change with respect to the shaft.

In another embodiment of the present turbocharger it is provided, furthermore, that the bearing comprises bores, passages and an oil distributor for supplying the bearing with lubricant. There it is favorable that the axial bearings and the radial bearings can be supplied with lubricating oil by the bores, circumferential passages and the oil distributor.

In a preferred embodiment of the invention, the cross-sectional area of the bores, passages and/or of the oil distributor continuously tapers from the oil distributor on a bearing housing up to the bearing body. Because of this, the pressure losses of the oil distributor system are kept as low as possible. In addition, the required installation space for the oil distributor can be reduced because of the low radial extent of the bearing body. Furthermore, the length-related pressure losses of the distributor system are reduced through the compact design.

### BRIEF DESCRIPTION OF THE DRAWINGS

Other advantageous further developments of the invention are shown in more detail by way of the FIGURE in the following together with the description of the preferred embodiment of the invention. In the drawing:

The FIGURE is a sectional view of an exhaust gas turbocharger having a compressor wheel, a turbine and a shaft which rotatably interconnects the compressor wheel and the turbine.

### DETAILED DESCRIPTION OF THE PRESENTLY PREFERRED EMBODIMENTS

In the FIGURE, a sectional view of an exhaust gas turbocharger 1 having a compressor wheel 2, a turbine 3 and a shaft 4, which rotatably interconnects the compressor wheel 2 and the turbine 3, is shown. On the shaft 4 a thrust ring 6, preferentially a one-piece thrust ring 6, is arranged, which indirectly connects the shaft 4 with the bearing 5 and is configured to transmit the axial forces acting on the shaft 4 both in a thrust direction S and also in the counter-thrust direction GS opposite to the thrust direction. The thrust ring 6 is hollow-cylindrically and non-positively arranged on the shaft 4. Furthermore, the thrust ring 6, at an end facing to the turbine 3, extends at a right angle to the outside such that the sectional view is L-shaped. Through this extent, the thrust ring 6 has a thrust surface 7 and a counter-thrust surface 14. For absorbing the axial force in the thrust direction S, the thrust surface 7 lies against the bearing 5 such that axial forces in the direction of the compressor wheel 2 are absorbed by the bearing 5. By contrast, for absorbing the axial force in the counter-thrust direction GS, the counter-thrust surface 14 lies against the bearing 5 such that axial forces in the direction of the turbine 3 are absorbed by the bearing 5. In addition to this, the thrust ring 6 lies against a shaft shoulder 11 with a part of the counter-thrust surface 14. The diameter of the shaft 4 from the shaft shoulder 11 in the direction of the turbine 3 has a larger diameter than a diameter of the shaft 4 from the shaft shoulder 11 in the direction of the compressor wheel 2.

Furthermore, the bearing 5 is formed of a bearing housing 8 and a bearing body 9 of a stator 10 of the exhaust gas turbocharger 1. In the bearing body 9, a thrust bearing is integrated which is in contact with the thrust surface 7 of the thrust ring 6 and is configured to absorb axial forces in the direction of the compressor wheel 2. Within the bearing housing 8, a region 15 is formed in which water or oil for the lubrication of the exhaust gas turbocharger is provided. Furthermore, the bearing housing 8 comprises a recess against which the thrust ring 6 lies with the counter-thrust surface 14 for absorbing the axial forces in the direction of the turbine 3. On this recess, a through-opening is arranged in the bearing housing 8 which is configured to discharge the water or the oil for lubrication to an oil drain 16.

Furthermore, the bearing 5 comprises bores, passages and an oil distributor for supplying the bearing 5 with lubricant. There, the cross-sectional area of the bores, passages and of the oil distributor steadily tapers from the oil distributor on the bearing housing 8 to the bearing body 9.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

I claim:

1. An exhaust gas turbocharger (1) comprising:
a compressor wheel (2);
a turbine (3); and
a shaft (4) configured to rotatably interconnect the compressor wheel (2) and the turbine (3),
wherein the shaft (4) is mounted in the turbocharger (1) by a bearing (5) configured to absorb axial forces acting on the shaft;
the turbocharger (1) further comprising a one-piece thrust ring (6) arranged on the shaft (4), wherein the one-piece thrust ring (6) indirectly connects the shaft (4) with the bearing (5) and is configured to transmit the axial forces acting on the shaft (4) both in a thrust direction (S) and in a counter-thrust direction (GS) opposite to the thrust direction.

2. The exhaust gas turbocharger (1) according to claim 1, wherein the thrust ring (6) comprises:
a thrust surface (7) configured to absorb the axial forces in the thrust direction, the thrust surface (7) lying against the bearing (5) such that axial forces in a direction of the compressor wheel (2) are absorbed by the bearing (5), and
a counter-thrust surface (14) configured to absorb the axial force in the counter-thrust direction, counter-thrust surface (14) lying against the bearing (5) such that axial forces in a direction of the turbine (3) are absorbed by the bearing (5).

3. The exhaust gas turbocharger (1) according to claim 2, wherein the bearing (5) is formed of a bearing housing (8) and a bearing body (9) of a stator (10).

4. The exhaust gas turbocharger (1) according to claim 3, wherein a thrust bearing is integrated in the bearing body (9), the thrust bearing being in contact with the thrust surface (7) of the thrust ring (6) and configured to absorb axial forces in the direction of the compressor wheel (2).

5. The exhaust gas turbocharger (1) according to claim 3, wherein the thrust ring (6) with the counter-thrust surface (14) lies against the bearing housing (8) so as to absorb the axial forces in the direction of the turbine (3).

6. The exhaust gas turbocharger (1) according to claim 5, further comprising a force transmission component arranged between the thrust ring (6) and the bearing housing (8).

7. The exhaust gas turbocharger (1) according to claim 2, wherein the thrust ring (6) is non-positively arranged on the shaft (4) and contacts a shaft shoulder (11) by a part of the counter-thrust surface (14).

8. The exhaust gas turbocharger (1) according to claim 3, wherein the bearing (5) comprises bores, passages and an oil distributor so as to supply the bearing with lubricant.

9. The exhaust gas turbocharger (1) according to claim 8, wherein a cross-sectional area of the bores, passages and/or of the oil distributor steadily tapers from the oil distributor on the bearing housing (8) to the bearing body (9).
